(19) United States
(12) Patent Application Publication
(10) Pub. No.: US 2003/0055786 A1
(43) Pub. Date: Mar. 20, 2003

(54) Credit card transaction authority by content rating

(75) Inventors: Newton James Smith JR., Austin, TX (US); Herman Rodriguez, Austin, TX (US); James Aloysius Donnelly, Austin, TX (US); Ron Saint Pierre, Austin, TX (US)

Correspondence Address: The Biggers Law Firm, 2608 Mason Street, Houston, TX, 77006, US

(73) Assignee: INTERNATIONAL BUSINESS MACHINES CORPORATION, ARMONK, NY

(21) Appl. No.: 09/956,762

(22) Filed: Sep. 20, 2001

(51) Int. Cl. G06F 17/60; G06K 5/00

(52) U.S. Cl. 705/44; 235/380; 705/39

(57) ABSTRACT

Administration of credit account transaction authority including receiving a request for authorization for a credit transaction against a credit account for purchase of at least one item available for purchase through credit transactions, wherein the item available for purchase has a content rating, and wherein the credit account has a content rating, an account owner, and at least one authorized account user; comparing the content rating of the item requested for purchase and the content rating of the credit account, wherein the comparing produces a determination whether the content rating of the item requested for purchase matches the content rating of the credit account; and authorizing the requested transaction when the content rating of the item requested for purchase matches the content rating of the credit account.

### BACKGROUND OF THE INVENTION

1. Field of the Invention

The field of the invention is credit transaction processing, or, more specifically, methods, systems, and products for administration of credit card transaction authority.

2. Description of Related Art

Prior art systems have allowed available credit for a credit account to be determined by someone other than the card issuer and allowed limits to be set on the number of expenditures that can be made. Prior art systems have allowed parents to control the use of ancillary credit or debit transaction cards issued to children. Prior art included administration by use of cards of prepaid amounts for certain categories of goods and services. Prior art included so-called ‘smart cards’ having some computational ability installed upon the cards, although the computational ability was generally limited in use to credit amount verification and security checks to validate the identity of a card or account user. Prior art card methods and systems, however, lacked the ability to authorize transactions based upon indications of user preference. Prior art methods and systems lacked the ability to categorize goods and services according to content so as to support authorization based upon such content.

Consider, for the sake of illustration, the case of cash. When an employer hands cash to an employee for use in purchasing office supplies, there is within the cash absolutely no functional limitation restricting purchases to office supplies. The employer may have internal controls and administrative procedures designed to assure that expenditures are limited to intended purposes, but the cash itself in fact can be spent on anything. In fact, prior art credit account administration is very similar to the case of cash.

In fashion very similar to cash, typical prior art credit card accounts have no functional or substantive limitations whatsoever. Prior art credit card accounts have credit maxima, but credit maxima, except for the obvious amount limitation, have no effect on what can be purchased with a credit card. When a parent authorizes a prior art credit card for a child, therefore, the parent has absolutely no way within the credit card or the credit card account itself to control expenditures using the card. Parents no doubt have many practical prior art ways of controlling the spending behavior of children, but none of those ways are implemented through the prior art credit cards as such. Accordingly therefore, there is a real need in the art for systems and methods in which the use of credit accounts is authorized according to the preferences of account owners and the content of goods and services, so that owners of credit card accounts and other credit accounts can implement expenditure controls within the account arrangements themselves.

### SUMMARY

Embodiments of the invention include methods for administration of credit account transaction authority including receiving a request for authorization for a credit transaction against a credit account for purchase of at least one item available for purchase through credit transactions, wherein the item available for purchase has a content rating, and wherein the credit account has a content rating, an account owner, and at least one authorized account user. Embodiments include comparing the content rating of the item requested for purchase and the content rating of the credit account, wherein the comparing produces a determination whether the content rating of the item requested for purchase matches the content rating of the credit account. Embodiments include authorizing the requested transaction when the content rating of the item requested for purchase matches the content rating of the credit account.

Typical embodiments of the invention include retrieving, from a ratings repository or a credit card company, the content rating of the credit account. Typical embodiments of the invention also include account owners having preferences regarding the content rating of the credit account and assigning the content rating to the credit account in dependence upon the account owner's preferences. Assigning a content rating in typical embodiments includes editing by the account owner of the content rating of the credit account and editing by the account owner of the content rating of the credit account on-line through a web site of a credit card company. In many embodiments, the credit account is a credit card account.

Further embodiments of the invention comprise content ratings including several content categories, each category having its own values. In typical embodiments, the content rating includes a primary content label having primary content values, a secondary content label having secondary content values, and a content descriptor having content descriptor values. Typical embodiments comprise a content rating including a maximum value for a credit account transaction, a timing code indicating when credit account transactions are enabled, a governmental restriction having governmental restriction values, and a merchant rating having merchant rating values. Content ratings in many embodiments also include an age category indicating the minimum age requirements for authorized account users.

In addition to the method aspects of the invention, further aspects of the invention include embodiments as computer systems and computer program products. The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating embodiments of a system aspect of the invention.

FIG. 2 is a control flow diagram illustrating various embodiments of method aspects.

FIG. 3 illustrates embodiments of content ratings useful within the scope of the present invention.

FIG. 4 illustrates as a use case an embodiment of a credit account content rating.

FIG. 5 illustrates as a use case a further embodiment of a credit account content rating.

### DETAILED DESCRIPTION OF EXEMPLARY EMBODIMENTS

### Introduction

The present invention is described to a large extent in this specification in terms of methods for credit transaction processing or, more specifically, methods, systems, and products for administration of credit card transaction authority. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory data elements and programmed steps of the method of the invention for execution by a processing unit as computer program instructions, which computer memory includes electronic circuits configured to store data and program instructions. The invention also is embodied in a computer program product, such as a diskette or other recording medium, for use with any suitable data processing system.

Embodiments of a computer program product typically are implemented by use of any recording media for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute” are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.”

The terms “client,” “client device,” and “device” are used as synonyms in this specification, referring to any device capable of accessing a server through a network. Examples of client devices are personal computers, special purpose devices that are internet-enabled, internet-capable personal data organizers, and others that will occur to those of skill in the art. Various embodiments of client devices are capable of wired and/or wireless network access. The use as a client device of any instrument capable of accessing a server through a network is well within the present invention.

A “browser” is a software application typically installed and running upon a client device, the browser operating to download to the client device from a web server documents developed in a markup language, display the contents of the documents, and to the extent that the documents include tags identifying other documents to download or other actions to be taken, downloading the documents or taking the actions.

“Coupled for data communications” means any form of data communications, wireless, infrared, radio, internet protocols, HTTP protocols, email protocols, networked, direct connections, dedicated phone lines, dial-ups, and other forms of data communications as will occur to those of skill in the art.

The term “network” is used in this specification to mean any networked coupling for data communications. Examples of networks useful with the invention include intranets, extranets, internets, local area networks, wide area networks, and other network arrangements as will occur to those of skill in the art. The use of any networked coupling from client devices to one or more content servers is well within the scope of the present invention.

“World Wide Web,” or more simply “the web,” refers to the well-known system of internet protocol (“IP”) servers that support specially formatted documents, documents formatted in a language called HTML for HyperText Markup Language. The term “web” is used in this specification also to refer to any server or connected group or interconnected groups of servers that implement the HyperText Transport Protocol, “HTTP,” in support of URLs and HTML documents, regardless whether such servers or groups of servers are coupled to the world wide web as such.

### Detailed Description

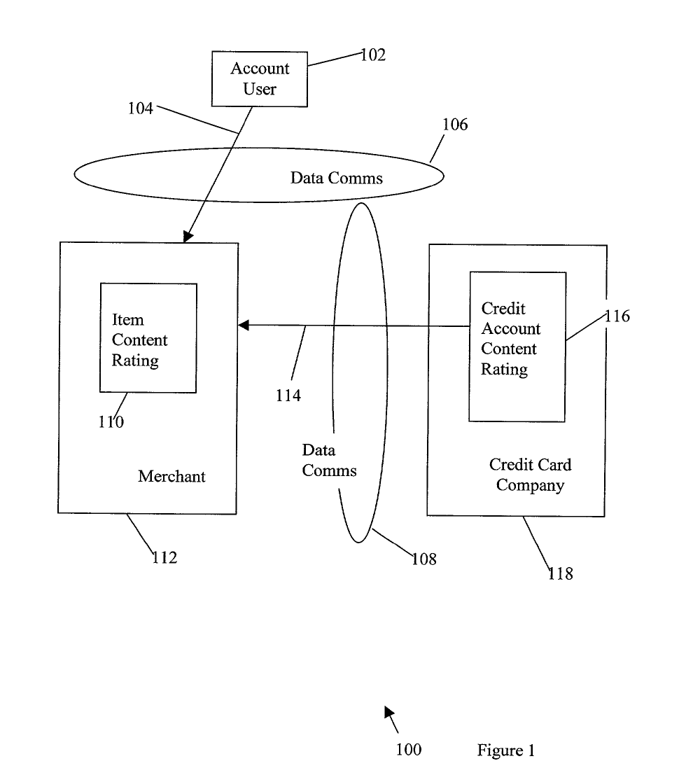

Turning now to FIG. 1, a first aspect of the invention is seen illustrated as embodiments of a system for credit account transaction authority. An embodiment according to FIG. 1 includes a merchant (112) that in typical embodiments is implemented as a commercial web site. Of course many embodiments include brick and mortar merchants such as movies, restaurants, office supplies, lumber yards, etc. The merchant of the illustrated embodiment is coupled for data communications (106) to an account user (102). Embodiments of the account user (102) typically include a browser coupled through a network connection to a merchant web site. The illustrated embodiment includes the merchant coupled for data communications (108) to a source of credit account content ratings, a ratings repository, in the illustrated embodiment, a credit card company (118), although other embodiments use a credit bureau, a special purpose services company, or other organizations as sources of credit account content ratings.

In typical embodiments according to FIG. 1 the merchant system includes the capabilities of receiving (104) from an account user a request for authorization for a credit transaction regarding an item to be purchased, where the item for purchase has a content rating (110), and the credit account has a content rating (116) and at least one authorized account user (102). In typical embodiments according to FIG. 1, the merchant system (112) is also capable of retrieving (114) from a ratings repository (118) the content rating of the credit account, comparing the content rating of the item for purchase and the content rating of the credit account, and authorizing the requested transaction when the content rating of the item requested for purchase matches the content rating of the credit account. The ratings repository is any data storage mechanism capable of being coupled for data communications (108) to a merchant system (112) and storing to provide upon request credit account content ratings.

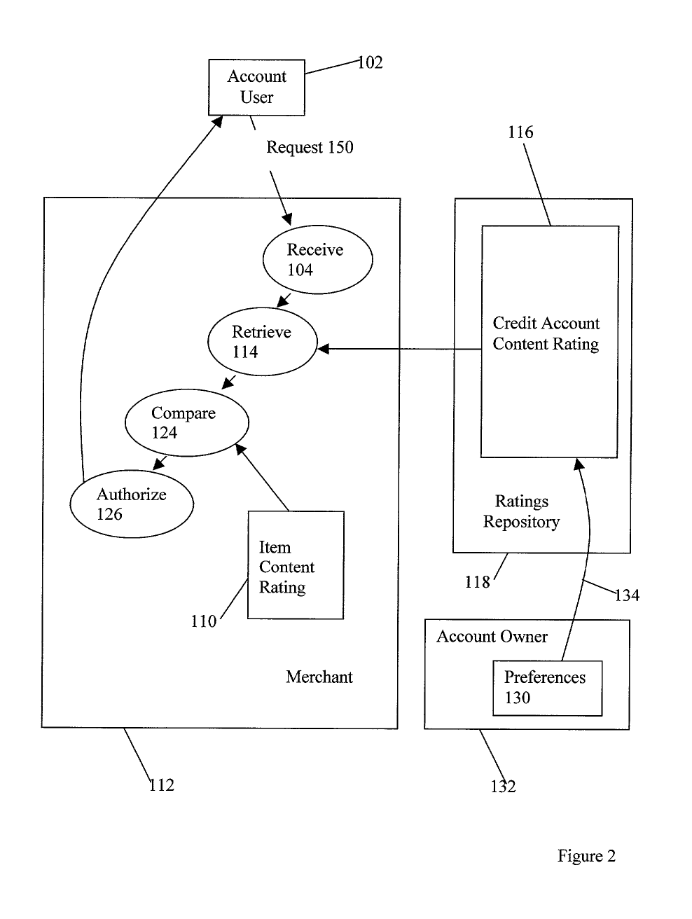

Turning now to FIG. 2, further embodiments of the invention are illustrated as a method for administration of credit account transaction authority. Typical embodiments of the kind shown in FIG. 2 include receiving (104) a request (150) for authorization for a credit transaction against a credit account for purchase of at least one item available for purchase through credit transactions. In such embodiments, the item available for purchase has a content rating (110), and the credit account has a content rating (116), an account owner (132), and at least one authorized account user (102). Typical embodiments include comparing (124) the content rating of the item requested for purchase and the content rating of the credit account, wherein the comparing produces a determination whether the content rating of the item requested for purchase matches the content rating of the credit account. Such embodiments typically include authorizing (126) the requested transaction when the content rating of the item requested for purchase matches the content rating of the credit account. In many embodiments, the credit account is a credit card account.

Typical embodiments of the invention as shown in FIG. 2 include retrieving (114) the content rating of the credit account (116). Retrieving the content rating of the credit account in typical embodiments includes retrieving from a ratings repository (118) the content rating of the credit account. In typical embodiments of the kind illustrated, the step of retrieving the content rating of the credit account also includes retrieving from a credit card company the content rating of the credit account.

Typical embodiments of the kind illustrated in FIG. 2 include an account owner (132) having preferences (130) regarding the content rating of the credit account. Typical embodiments include assigning the content rating (134) to the credit account in dependence upon the account owner's preferences. In typical embodiments of the invention, the step of assigning a content rating (134) includes editing by the account owner of the content rating of the credit account. The step of assigning a content rating (134) also includes in many embodiments editing by the account owner of the content rating of the credit account on-line through a web site of a credit card company.

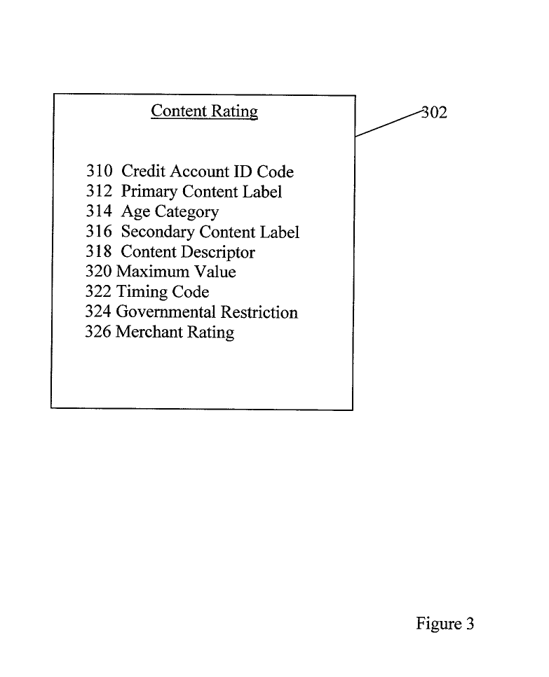

In typical embodiments of the invention, as illustrated in FIG. 3, the method includes at least one item available for purchase. In typical embodiments, the item available for purchase has a content rating (302) which includes a primary content label (312) having primary content values. In typical embodiments, the primary content values may be “personal” or “commercial.” Those values are examples only. Many useful primary content values will occur to persons skilled in the art, and all such values are well within the scope of the present invention.

In typical embodiments of the kind shown in FIG. 3, the method further includes a content rating (302) which includes an age category (314) indicating the minimum age requirement for an authorized account user. In typical embodiments, the content rating (302) also includes a secondary content label (316) having secondary content values. In typical embodiments of the invention, the secondary content values may include “necessity”, “optional”, “entertainment” or “luxury.” Those values are examples only. Many useful secondary content values will occur to those of skill in the art, and all such values are well within the scope of the present invention.

In typical embodiments of the kind illustrated in FIG. 3, the method includes a content rating (302) which includes a content descriptor (318) having content descriptor values. In typical embodiments the content description values may include goods or services. Those values are examples only. Many useful content description values will occur to persons skilled in the art, and all such values are well within the scope of the present invention.

As illustrated in FIG. 3, the method includes a content rating (302) which includes a maximum value (320) for a credit account transaction. In typical embodiments, the maximum value includes a maximum amount of money authorized for a credit account transaction. In typical embodiments, the content rating also includes a timing code (322) indicating when credit account transactions are enabled, the timing code having timing code values. In typical embodiments, the timing code values include a restricted date, a restricted time, and a restricted transaction frequency.

In typical embodiments of the invention, the method also includes a content rating (302) which includes a governmental restriction (324) having governmental restriction values. In typical embodiments, the governmental restriction values include a minimum age for purchase of alcoholic beverages, an indication of a confirmation requirement for purchase of handguns, or a minimum age requirement for purchase of cigarettes. Those values are examples only. Many useful governmental restriction values will occur to those of skill in the art, and all such values are well within the scope of the present invention.

In typical embodiments of the kind illustrated in FIG. 3, the method further includes a content rating (302) which includes a merchant rating (326) having merchant rating values. In typical embodiments, the merchant rating values may include an indication that a merchant is a general merchandising merchant, a specialty store, a retail merchant of consumables, a wholesale merchant of durable goods, a provider of entertainment services, or a provider of financial services. Those values are examples only. Many useful merchant rating values will occur to persons skilled in the art, and all such values are well within the scope of the present invention.

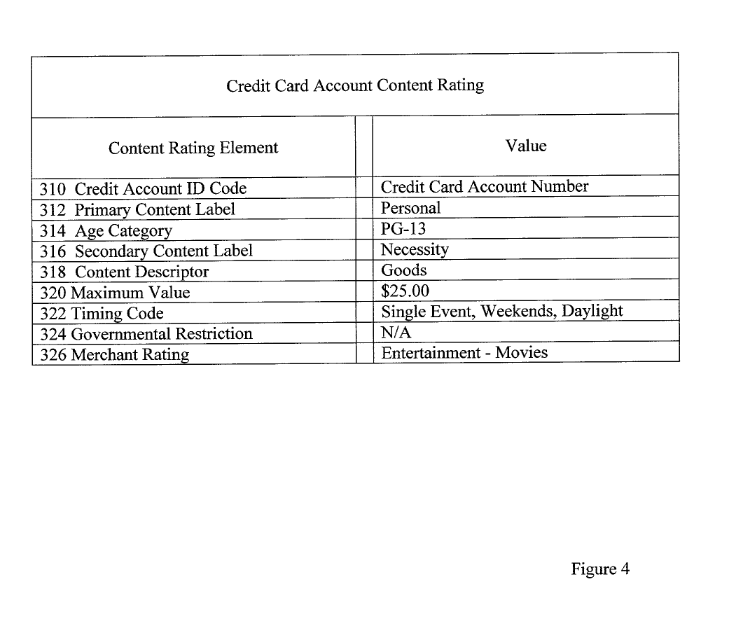

Turning now to FIG. 4, a further embodiment of the invention is illustrated as a use case involving a credit card account bearing content ratings appropriate for use by a child as an authorized user of an account owned by the child's parents. In the illustrated embodiment, the credit card account content rating is set to allow personal charges for goods appropriate for a child according to age category “PG-13.” The content rating limits purchases to $25.00 for single events only in daylight on weekends and only for movies rated PG-13 or less. In effect, the parent has limited the use of this card to purchases of soft drinks, popcorn, and candy in a motion picture theatre on weekends during the day. Very little else would be available for purchase by use of the illustrated embodiment of a credit card account content rating of FIG. 4. It is useful to remember that the parent-owners of the account illustrated in FIG. 4 effected these limitations in typical embodiments merely by taking three minutes to log on to the credit card company web site and enter the limitations, the content ratings, through a data entry dialogue box on a browser screen.

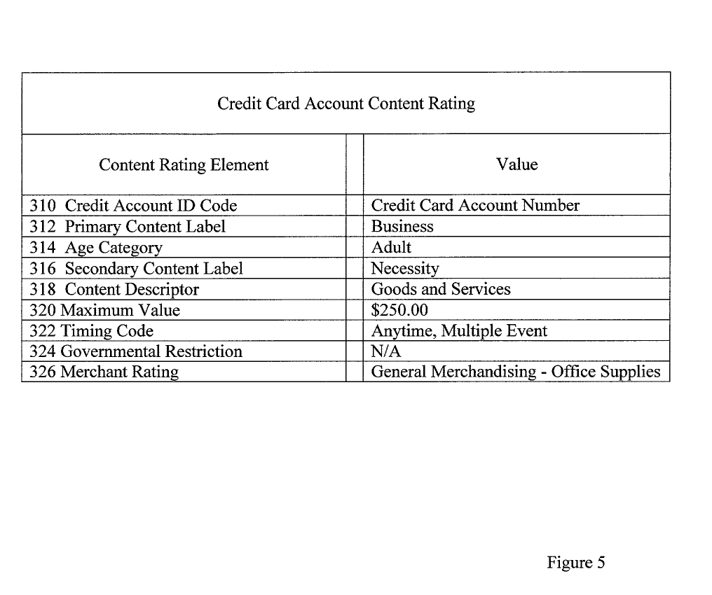

Turning now to FIG. 5, a further embodiment of the invention is illustrated as a use case involving a credit card account bearing content ratings appropriate for use by an employee as an authorized user of an account owned by a company that uses office supplies. In the illustrated embodiment, the credit card account content rating is set to allow business charges of the kind effected by adults as necessities, including both goods and services. The content rating in the embodiment of FIG. 5 limits purchases to $250.00 for multiple events with no time limitation. The content rating of FIG. 5 authorizes charges for general merchandising as office supplies. In effect, the company that owns the credit card account of FIG. 5 has limited the use of the illustrated card to purchases of office supplies not to exceed $250.00 per transaction although multiple transactions are authorized. It is useful to remember that the company's credit manager for the account illustrated in FIG. 5 effected these limitations in typical embodiments merely by taking three minutes to log on to a credit card company web site and enter the limitations, the content ratings, through a data entry dialogue box on a browser screen.

The scope of the invention is in no way limited by the particular elements of content ratings discussed in this specification. Additional embodiments include, for example, content ratings fields for drugs, to prevent accidental acquisition by account users of drugs dangerous in combination, useful for both prescription drugs and nonprescription drugs. Other embodiments include, for example, content ratings on automobile fuels, to prevent accidental acquisition of fuels that will not work properly in an account user's automobile. Other embodiments include, for example, content ratings on electronic products such as video and audio programs and software applications, updates, and upgrades, available for purchase and download across the Internet, to prevent accidental acquisition of electronic products that will not work correctly on a particular account user's computer. Many other embodiments of content ratings will occur to those of skill in the art, and all of them are well within the scope of the present invention.

It will be understood from the foregoing description that various modifications and changes may be made in the various embodiments of the present invention without departing from its true spirit. It is intended that the descriptions in this specification are for purposes of illustration only and are not to be construed in a limiting sense. The scope of the present invention is limited only by the language of the following claims.

What is claimed is:

1. A method for administration of credit account transaction authority, the method comprising the steps of:
receiving a request for authorization for a credit transaction against a credit account for purchase of at least one item available for purchase through credit transactions, wherein the item available for purchase has a content rating, and wherein the credit account has a content rating, an account owner, and at least one authorized account user;
comparing the content rating of the item requested for purchase and the content rating of the credit account, wherein the comparing produces a determination whether the content rating of the item requested for purchase matches the content rating of the credit account; and
authorizing the requested transaction when the content rating of the item requested for purchase matches the content rating of the credit account.

2. The method of claim 1 further comprising retrieving the content rating of the credit account.

3. The method of claim 2 wherein retrieving the content rating of the credit account further comprises retrieving from a ratings repository the content rating of the credit account.

4. The method of claim 2 wherein retrieving the content rating of the credit account further comprises retrieving from a credit card company the content rating of the credit account.

5. The method of claim 1 wherein the account owner has preferences regarding the content rating of the credit account and the method further comprises assigning the content rating to the credit account in dependence upon the account owner's preferences.

6. The method of claim 5 wherein assigning a content rating further comprises editing by the account owner of the content rating of the credit account.

7. The method of claim 5 wherein assigning a content rating further comprises editing by the account owner of the content rating of the credit account on-line through a web site of a credit card company.

8. The method of claim 1 wherein the credit account is a credit card account.

9. The method of claim 1 wherein the content rating comprises a primary content label having primary content values.

10. The method of claim 9 wherein the primary content values comprise “personal.”

11. The method of claim 9 wherein the primary content values comprise “commercial.”

12. The method of claim 1 wherein the content rating comprises an age category indicating the minimum age requirement for an authorized account user.

13. The method of claim 1 wherein the content rating comprises a secondary content label having secondary content values.

14. The method of claim 13 wherein the secondary content values comprise “necessity.”

15. The method of claim 13 wherein the secondary content values comprise “optional.”

16. The method of claim 13 wherein the secondary content values comprise “entertainment.”

17. The method of claim 13 wherein the secondary content values comprise “luxury.”

18. The method of claim 1 wherein the content rating comprises a content descriptor having content descriptor values.

19. The method of claim 18 wherein the content description values comprise “goods.”

20. The method of claim 18 wherein the content description values comprise “services.”

21. The method of claim 1 wherein the content rating comprises a maximum value for a credit account transaction.

22. The method of claim 21 wherein the maximum value comprises a maximum amount of money authorized for a credit account transaction.

23. The method of claim 1 wherein the content rating comprises a timing code indicating when credit account transactions are enabled, the timing code having timing code values.

24. The method of claim 23 wherein the timing code values comprise a restricted date.

25. The method of claim 23 wherein the timing code values comprise a restricted time.

26. The method of claim 23 wherein the timing code values comprise a restricted transaction frequency.

27. The method of claim 1 wherein the content rating comprises a governmental restriction having governmental restriction values.

28. The method of claim 27 wherein the governmental restriction values comprise a minimum age for purchase of alcoholic beverages.

29. The method of claim 27 wherein the governmental restriction values comprise an indication of a confirmation requirement for purchase of handguns.

30. The method of claim 27 wherein the governmental restriction values comprise a minimum age for purchase of cigarettes.

31. The method of claim 1 wherein the content rating comprises a merchant rating having merchant rating values.

32. The method of claim 31 wherein the merchant rating values comprise an indication that a merchant is a general merchandising merchant.

33. The method of claim 31 wherein the merchant rating values comprise an indication that a merchant is a specialty store.

34. The method of claim 31 wherein the merchant rating values comprise an indication that a merchant is a retail merchant of consumables.

35. The method of claim 31 wherein the merchant rating values comprise an indication that a merchant is a wholesale merchant of durable goods.

36. The method of claim 31 wherein the merchant rating values comprise an indication that a merchant is a provider of entertainment services.

37. The method of claim 31 wherein the merchant rating values comprise an indication that a merchant is a provider of financial services.

38. The method of claim 31 wherein the merchant rating values comprise an indication that a merchant is a retail merchant of durable goods.

39. A system for administration of credit account transaction authority, the system comprising the steps of:
means for receiving a request for authorization for a credit transaction against a credit account for purchase of at least one item available for purchase through credit transactions, wherein the item available for purchase has a content rating, and wherein the credit account has a content rating, an account owner, and at least one authorized account user;
means for comparing the content rating of the item requested for purchase and the content rating of the credit account, wherein the means for comparing has a capability of producing a determination whether the content rating of the item requested for purchase matches the content rating of the credit account; and
means for authorizing the requested transaction when the content rating of the item requested for purchase matches the content rating of the credit account.

40. The system of claim 39 further comprising means for retrieving the content rating of the credit account.

41. The system of claim 40 wherein means for retrieving the content rating of the credit account further comprises means for retrieving from a ratings repository the content rating of the credit account.

42. The system of claim 40 wherein means for retrieving the content rating of the credit account further comprises means for retrieving from a credit card company the content rating of the credit account.

43. The system of claim 39 wherein the account owner has preferences regarding the content rating of the credit account and the system further comprises means for assigning the content rating to the credit account in dependence upon the account owner's preferences.

44. The system of claim 43 wherein means for assigning a content rating further comprises means for editing by the account owner of the content rating of the credit account.

45. The system of claim 43 wherein means for assigning a content rating further comprises means for editing by the account owner of the content rating of the credit account on-line through a web site of a credit card company.

46. The system of claim 39 wherein the credit account comprises a credit card account.

47. The system of claim 39 wherein the content rating comprises a primary content label having primary content values.

48. The system of claim 47 wherein the primary content values comprise “personal.”

49. The system of claim 47 wherein the primary content values comprise “commercial.”

50. The system of claim 39 wherein the content rating comprises an age category indicating the minimum age requirement for an authorized account user.

51. The system of claim 39 wherein the content rating comprises a secondary content label having secondary content values.

52. The system of claim 51 wherein the secondary content values comprise “necessity.”

53. The system of claim 51 wherein the secondary content values comprise “optional.”

54. The system of claim 51 wherein the secondary content values comprise “entertainment.”

55. The system of claim 51 wherein the secondary content values comprise “luxury.”

56. The system of claim 39 wherein the content rating comprises a content descriptor having content descriptor values.

57. The system of claim 56 wherein the content description values comprise “goods.”

58. The system of claim 56 wherein the content description values comprise “services.”

59. The system of claim 39 wherein the content rating comprises a maximum value for a credit account transaction.

60. The system of claim 59 wherein the maximum value comprises a maximum amount of money authorized for a credit account transaction.

61. The system of claim 39 wherein the content rating comprises a timing code indicating when credit account transactions are enabled, the timing code having timing code values.

62. The system of claim 61 wherein the timing code values comprise a restricted date.

63. The system of claim 61 wherein the timing code values comprise a restricted time.

64. The system of claim 61 wherein the timing code values comprise a restricted transaction frequency.

65. The system of claim 39 wherein the content rating comprises a governmental restriction having governmental restriction values.

66. The system of claim 65 wherein the governmental restriction values comprise a minimum age for purchase of alcoholic beverages.

67. The system of claim 65 wherein the governmental restriction values comprise an indication of a confirmation requirement for purchase of handguns.

68. The system of claim 65 wherein the governmental restriction values comprise a minimum age for purchase of cigarettes.

69. The system of claim 39 wherein the content rating comprises a merchant rating having merchant rating values.

70. The system of claim 69 wherein the merchant rating values comprise an indication that a merchant is a general merchandising merchant.

71. The system of claim 69 wherein the merchant rating values comprise an indication that a merchant is a specialty store.

72. The system of claim 69 wherein the merchant rating values comprise an indication that a merchant is a retail merchant of consumables.

73. The system of claim 69 wherein the merchant rating values comprise an indication that a merchant is a wholesale merchant of durable goods.

74. The system of claim 69 wherein the merchant rating values comprise an indication that a merchant is a provider of entertainment services.

75. The system of claim 69 wherein the merchant rating values comprise an indication that a merchant is a provider of financial services.

76. The system of claim 69 wherein the merchant rating values comprise an indication that a merchant is a retail merchant of durable gods.

77. A computer program product for administration of credit account transaction authority, the system comprising the steps of:
a recording medium;
means, recorded on the recording medium, for receiving a request for authorization for a credit transaction against a credit account for purchase of at least one item available for purchase through credit transactions, wherein the item available for purchase has a content rating, and wherein the credit account has a content rating, an account owner, and at least one authorized account user;
means, recorded on the recording medium, for comparing the content rating of the item requested for purchase and the content rating of the credit account, wherein the means for comparing has a capability of producing a determination whether the content rating of the item requested for purchase matches the content rating of the credit account; and
means, recorded on the recording medium, for authorizing the requested transaction when the content rating of the item requested for purchase matches the content rating of the credit account.

78. The computer program product of claim 77 further comprising means, recorded on the recording medium, for retrieving the content rating of the credit account.

79. The computer program product of claim 78 wherein means, recorded on the recording medium, for retrieving the content rating of the credit account further comprises means, recorded on the recording medium, for retrieving from a ratings repository the content rating of the credit account.

80. The computer program product of claim 78 wherein means, recorded on the recording medium, for retrieving the content rating of the credit account further comprises means, recorded on the recording medium, for retrieving from a credit card company the content rating of the credit account.

81. The computer program product of claim 77 wherein the account owner has preferences regarding the content rating of the credit account and the computer program product further comprises means, recorded on the recording medium, for assigning the content rating to the credit account in dependence upon the account owner's preferences.

82. The computer program product of claim 81 wherein means, recorded on the recording medium, for assigning a content rating further comprises means, recorded on the recording medium, for editing by the account owner of the content rating of the credit account.

83. The computer program product of claim 81 wherein means, recorded on the recording medium, for assigning a content rating further comprises means, recorded on the recording medium, for editing by the account owner of the content rating of the credit account on-line through a web site of a credit card company.

84. The computer program product of claim 77 wherein the credit account is a credit card account.

85. The computer program product of claim 77 wherein the content rating comprises a primary content label having primary content values.

86. The computer program product of claim 85 wherein the primary content values comprise “personal.”

87. The computer program product of claim 85 wherein the primary content values comprise “commercial.”

88. The computer program product of claim 77 wherein the content rating comprises an age category indicating the minimum age requirement for an authorized account user.

89. The computer program product of claim 77 wherein the content rating comprises a secondary content label having secondary content values.

90. The computer program product of claim 89 wherein the secondary content values comprise “necessity.”

91. The computer program product of claim 89 wherein the secondary content values comprise “optional.”

92. The computer program product of claim 89 wherein the secondary content values comprise “entertainment.”

93. The computer program product of claim 89 wherein the secondary content values comprise “luxury.”

94. The computer program product of claim 77 wherein the content rating comprises a content descriptor having content descriptor values.

95. The computer program product of claim 94 wherein the content description values comprise “goods.”

96. The computer program product of claim 94 wherein the content description values comprise “services.”

97. The computer program product of claim 77 wherein the content rating comprises a maximum value for a credit account transaction.

98. The computer program product of claim 97 wherein the maximum value comprises a maximum amount of money authorized for a credit account transaction.

99. The computer program product of claim 77 wherein the content rating comprises a timing code indicating when credit account transactions are enabled, the timing code having timing code values.

100. The computer program product of claim 99 wherein the timing code values comprise a restricted date.

101. The computer program product of claim 99 wherein the timing code values comprise a restricted time.

102. The computer program product of claim 99 wherein the timing code values comprise a restricted transaction frequency.

103. The computer program product of claim 77 wherein the content rating comprises a governmental restriction having governmental restriction values.

104. The computer program product of claim 103 wherein the governmental restriction values comprise a minimum age for purchase of alcoholic beverages.

105. The computer program product of claim 103 wherein the governmental restriction values comprise an indication of a confirmation requirement for purchase of handguns.

106. The computer program product of claim 103 wherein the governmental restriction values comprise a minimum age for purchase of cigarettes.

107. The computer program product of claim 77 wherein the content rating comprises a merchant rating having merchant rating values.

108. The computer program product of claim 107 wherein the merchant rating values comprise an indication that a merchant is a general merchandising merchant.

109. The computer program product of claim 107 wherein the merchant rating values comprise an indication that a merchant is a specialty store.

110. The computer program product of claim 107 wherein the merchant rating values comprise an indication that a merchant is a retail merchant of consumables.

111. The computer program product of claim 107 wherein the merchant rating values comprise an indication that a merchant is a wholesale merchant of durable goods.

112. The computer program product of claim 107 wherein the merchant rating values comprise an indication that a merchant is a provider of entertainment services.

113. The computer program product of claim 107 wherein the merchant rating values comprise an indication that a merchant is a provider of financial services.

114. The computer program product of claim 107 wherein the merchant rating values comprise an indication that a merchant is a retail merchant of durable goods.
